(19) United States
(12) Patent Application Publication
(10) Pub. No.: US 2010/0313478 A1
(43) Pub. Date: Dec. 16, 2010

(54) WEATHERING BLOCK FOR USE WITH WINDOWS AND DOORS

(76) Inventor: Stephen M. Montz, Bella Vista, AR (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/485,408

(22) Filed: Jun. 16, 2009

(51) Int. Cl. E06B 7/00

(52) U.S. Cl. 49/70

(57) ABSTRACT

Single-hung, double-hung, horizontal sliding/gliding windows, and sliding door assemblies having a weathering block of the present invention are disclosed herein. The weathering block of the present invention is an integral component of a window or door frame, and functions to substantially seal leaks around movable joints, such as windows or doors. In an embodiment, the weathering block substantially prevents air and water infiltration around windows and doors by substantially eliminating gaps between the frames and moving parts when they are closed. In an embodiment, the weathering block includes a back surface sufficiently designed to engage a side jamb, a head jamb, or a sill plate of a window or door frame; a front surface sufficiently designed to maintain weather-stripping; a first side surface sufficiently designed to maintain weather-stripping; and a second side surface sufficiently designed to maintain weather-stripping.

### BACKGROUND

Proper insulation and air sealing techniques can reduce the cost of heating and cooling a dwelling. Air leakage, or infiltration, occurs when outside air enters a dwelling through cracks and openings. Properly air sealing such cracks and openings can significantly reduce heating and cooling costs, improve building durability, and create a healthier indoor environment. Water leaks around windows and doors cause significant damage to homes and create an environment in which mold can grow. A water leak can go undetected for years requiring costly mold remediation and repair.

### SUMMARY

According to an embodiment of the present invention, there is disclosed a single-hung window that includes a frame having a head jamb, a sill plate, a first side jamb, and a second side jamb; a fixed lite window constructed in the frame, the fixed lite window having a fixed meeting rail member; a lower sash vertically moveable in the frame, the lower sash having a locking rail, a bottom rail, a first side stile, and a second side stile; and a first weathering block comprising: a back surface engaging the first side jamb of the frame; a front surface having weather-stripping; a first side surface sufficiently designed to maintain weather-stripping; and a second side surface sufficiently designed to maintain weather-stripping, wherein, when the lower sash is in a closed position the first side surface of the first weathering block contacts the fixed meeting rail of the fixed lite window and the second side surface of the first weathering block contacts the first side stile of the vertically moveable lower sash.

According to an embodiment of the present invention, there is disclosed a double-hung window that includes a frame having a head jamb, a sill plate, a first side jamb, and a second side jamb; a top sash vertically moveable in the frame, the top sash having a top rail, a keeper rail, a first side stile, and a second side stile; a lower sash vertically moveable in the frame, the lower sash having a locking rail, a bottom rail, a first side stile, and a second side stile; and a first weathering block comprising: a back surface engaging the first side jamb of the frame; a front surface having weather-stripping; a first side surface sufficiently designed to maintain weather-stripping; and a second side surface sufficiently designed to maintain weather-stripping, wherein, when the lower sash and the top sash are in a closed position the first side surface of the first weathering block contacts the first side stile of the top sash and the second side surface of the first weathering block contacts the first side stile of the lower sash.

According to an embodiment of the present invention, there is disclosed a horizontal sliding window that includes a frame having a head jamb, a sill plate, a first side jamb, and a second side jamb; a fixed lite window constructed in the frame, the fixed lite window having a fixed meeting stile member; at least one moveable sash in the frame, the sash having a top rail, a bottom rail, a first side stile, and a second side stile; a first weathering block comprising: a back surface engaging the head jamb of the frame; a front surface having weather-stripping; a first side surface sufficiently designed to maintain weather-stripping; and a second side surface sufficiently designed to maintain weather-stripping; and a second weathering block comprising: a back surface engaging the sill plate of the frame; a front surface having weather-stripping; a first side surface sufficiently designed to maintain weather-stripping; and a second side surface sufficiently designed to maintain weather-stripping.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1A and FIG. 1B illustrates an embodiment of a weathering block of the present invention. FIG. 1A is an isometric view of the weathering block taken from the front. FIG. 1B is an isometric view of the weathering block taken from the back;

FIG. 2A and FIG. 2B illustrates the weathering block of FIG. 1A and FIG. 1B, respectively, having weather-stripping. FIG. 2A is an isometric view of the weathering block having weather-stripping taken from the front. FIG. 2B is an isometric view of the weathering block having weather-stripping taken from the back;

FIG. 3A and FIG. 3B illustrates the weathering block of FIG. 2A and a side jamb of a single-hung window frame. FIG. 3A shows the weathering block prior to engagement to a center parting fin of the side jamb. FIG. 3B shows the weathering block after engagement to the center parting fin of the side jamb;

FIG. 4A and FIG. 4B illustrates an embodiment of a single-hung window having the weathering block of FIG. 2A. FIG. 4A shows the single-hung window as viewed from an interior of a dwelling. FIG. 4B shows the single-hung window as viewed from an exterior of a dwelling;

FIG. 5 is a fragmentary isometric view of some of the main components of the single-hung window of FIG. 4A;

FIG. 6 is a fragmentary isometric view of some of the main components of the single-hung window of FIG. 4B;

FIG. 7 is a fragmentary isometric view of some of the main components of a lower sash of a double-hung window having the weathering block of FIG. 2A.

While the above-identified drawings set forth presently disclosed embodiments, other embodiments arc also contemplated, as noted in the discussion. This disclosure presents illustrative embodiments by way of representation and not limitation. Numerous other modifications and embodiments can be devised by those skilled in the art which fall within the scope and spirit of the principles of the present invention.

### DETAILED DESCRIPTION

Single-hung, double-hung, horizontal sliding/gliding windows, and sliding door assemblies having a weathering block of the present invention are disclosed herein. A weathering block of the present invention is an integral component of a window or door frame, and functions to substantially seal leaks around movable joints, such as windows or doors. In an embodiment, the weathering block substantially prevents air and water infiltration around windows and doors by substantially eliminating gaps between the frames and moving parts when they are closed. A weathering block of the present invention includes a back surface sufficiently designed to engage a side jamb, a head jamb, or a sill plate of a window or door frame; a front surface sufficiently designed to maintain weather-stripping; a first side surface sufficiently designed to maintain weather-stripping; and a second side surface sufficiently designed to maintain weather-stripping. As used herein, the term “weather-stripping” refers to a material or device that can be used to substantially seal air or leaks around movable joints, such as windows or doors. Weather-stripping can substantially prevent air infiltration around windows and doors by substantially eliminating gaps between the frames and the moving parts when they are closed. A secondary goal of weather-stripping may be to keep interior air in, thus saving energy with heating and air conditioning.

As used herein, the term “sash” refers to the portion of a window or door that includes the glass and the framing sections directly attached to the glass, not to be confused with the complete frame into which the sash sections are fitted.

As used herein, the term “side jamb” refers to the vertical portion of a window or door frame.

As used herein, the term “fixed lite window” refers to a non-operating, non-opening window that is constructed in the frame of a window or a door.

As used herein, the term “single-hung window” refers to a window comprising two sashes, the top one stationary and the bottom moveable in a vertical direction. The top stationary sash can be considered a top fixed lite window.

As used herein, the term “double-hung window” refers to a window comprising two sashes of glass, both moveable in a vertical direction.

As used herein, the term “horizontal gliding window” refers to a window comprising two or more sashes that slide horizontally past each other; one or more of the sashes may be fixed or inoperative or all of the sashes may operate, in a closed position, the sashes come together to form a vertical meeting rail.

As used herein, the term “horizontal sliding window” refers to a window having one stationary sash and one sash that moves to the right or left in grooves or on tracks. As used herein, the term “engage”, “engaging” or “engaged” refers to contacting or to make contact with something.

As used herein, the term “closed position” with relation to a single-hung window refers to a lower moveable sash positioned in a single-hung window such that a bottom rail of the sash engages a sill plate of a frame of the single-hung window. As used herein, the term “closed position” with relation to a double-hung window refers to a top moveable sash positioned in a double-hung window such that a top rail of the sash engages a head jamb of a frame of the double-hung window. As used herein, the term “closed position” with relation to a double-hung window refers to a lower moveable sash positioned in a double-hung window such that a bottom rail of the sash engages a sill plate of a frame of the double-hung window. As used herein, the term “closed position” with relation to a horizontal sliding or gliding window refers to a moveable sash positioned in a horizontal sliding or gliding window such that a side stile of the sash engages one of the side jambs. As used herein, the term “closed position” with relation to a sliding door assembly refers to a moveable sash positioned in a sliding door assembly such that a side stile of the sash engages one of the side jambs.

As used herein, the term “interlock” refers to that portion of a window rail that can engage, by fitting together, with another window rail.

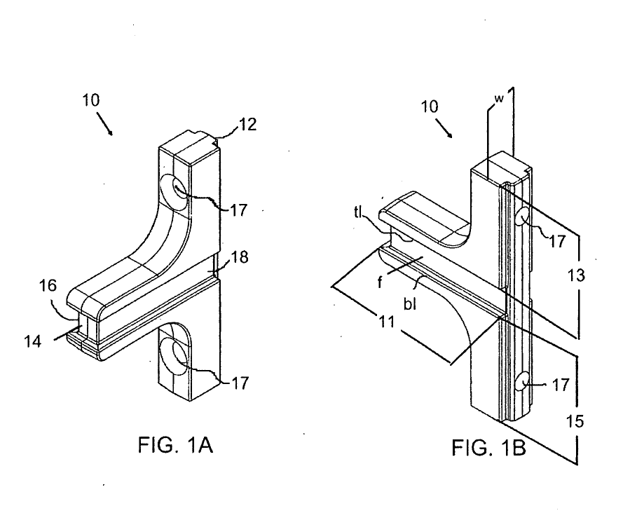

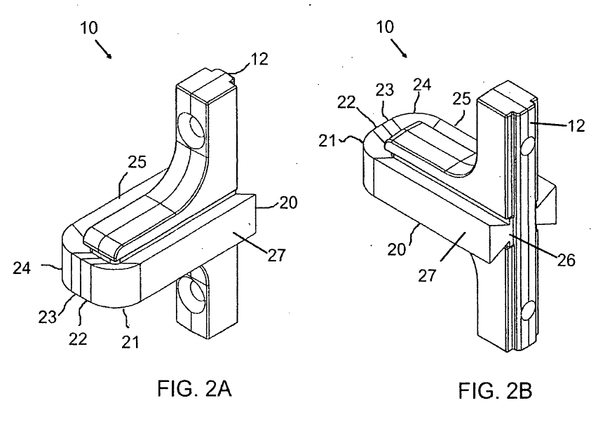

FIG. 1A and FIG. 1B illustrates an embodiment of a weathering block 10 of the present invention. As illustrated in the embodiment depicted in FIG. 1A and FIG. 1B, the weathering block 10 forms a “T”-shape, having a “leg” portion 11 and two “arm” portions 13 and 15. In an embodiment, the T-shaped weathering block 10 has a height (from top of arm portion 13 to bottom of arm portion 15) of approximately 1.6 inches. In an embodiment, the T-shaped weathering block 10 has a depth (distance of the leg portion 11) of approximately 1.3 inches. In an embodiment, the T-shaped weathering block 10 has a width w of approximately 0.26 inches. The weathering block 10 includes a back surface 12 sufficiently designed to engage a side jamb, a head jamb, or a sill plate of a window or door frame, a front surface 14, a first side surface 16, and a second side surface 18. The front surface 14, the first side surface 16, and the second side surface 18 are sufficiently designed to maintain weather-stripping, as illustrated in FIG. 2A and FIG. 2B and described below. Openings 17 of the weathering block 10 are designed for accepting fasteners, such as, screws, nuts, bolts, washers, and pins, for engagement to the window or the door frame. In another embodiment, the weathering block 10 can be manufactured without openings 17. For example, the weathering block 10 can engage a side jamb, a head jamb, or a sill plate of a window or door frame using other means known in the art, such as rivets, welding, gluing, taping, stapling, adhesives, and hook-and-loop fasteners (such as Velcro®).

Although the illustrative embodiment of the weathering block 10 of FIG. 1A and FIG. 1B is shown having a T-shape, in other embodiments the weathering block 10 can be manufactured into a wide variety of shapes, including, but not limited to, square, rectangular, triangular, circular, oval, octagonal, hexagonal, and others. The weathering block 10 manufactured into any one of these shapes includes a back surface sufficiently designed to engage a side jamb, a head jamb, or a sill plate of a window or door frame; a front surface, a first side surface, and a second side surface sufficiently designed to maintain weather-stripping; and should engage the window or door frame as described in the various figures below.

The weathering block 10 can be constructed from various materials including, but not limited to, metals, polymers, and wood. In an embodiment, the metal is an extruded or cast aluminum, aluminum alloy, or steel. In an embodiment, the polymer is a fiberglass reinforced plastic, such as DuPont™ Zytel® 33 percent glass reinforced nylon 66 resin. In an embodiment, the polymer is a thermoplastic material. In an embodiment, the thermoplastic material is polyvinyl chloride (PVC) or acrylonitrile butadiene styrene (ABS). The weathering block 10 can be manufactured by injection molding, casting, and machining fabrication methods.

As illustrated in FIG. 2A and FIG. 2B, the weathering block 10 is sufficiently designed to maintain materials that substantially stop air leakage or infiltration (e.g., weather-stripping). The second side surface 18 of the weathering block 10 is sufficiently designed to maintain weather-stripping piece 20. The front surface 14 of the weathering block 10 is sufficiently designed to maintain weather-stripping pieces, such as weather-stripping pieces 21, 22, 23 and 24. The first side surface 16 of the weathering block 10 is sufficiently designed to maintain weather-stripping piece 25. In another embodiment, the separate weather-stripping pieces 20-25 can be fabricated as a single weather-stripping piece so that a single weather-stripping piece is maintained in the second side surface 18, the front surface 14 and the first side surface 16. Examples of materials for use as weather-stripping pieces 20-25 include, but are not limited to, polypropylene, nylon, neoprene, urethane, silicone, or rubber strip, tubular and specialty type of weather-stripping. In the embodiments depicted in the various views, the weather-stripping pieces 20-25 have a polypropylene base 26, with an adhesive backing, and nylon fibers 27. In an embodiment, the adhesive backing is a high bond pressure sensitive adhesive tape. The adhesive backing is applied to the various surfaces (i.e., 14, 16 and 18) of the weathering block 10. Other methods of engaging the weather-stripping pieces 20-25 to the various surfaces (i.e., 14, 16 and 18) of the weathering block 10 include, but are not limited to, fasteners, screws, rivets, staples, glue, other tape methods or combinations thereof. In an embodiment, the weather-stripping pieces 20-25 engage the various surfaces (e.g., 14, 16 and/or 18) of the weathering block 10 via fasteners. In an embodiment, the fasteners are retention clips that attach to the surfaces (e.g., 14, 16 and/or 18). The retention clips can engage the various surfaces (e.g., 14, 16 and/or 18) along the face (f in FIG. 1B), along the top ledge (tl in FIG. 1B) and/or along the bottom ledge (bl in FIG. 1B). In an embodiment, the weather-stripping pieces 20-25 having the polypropylene base 26 with the adhesive backing engage the various surfaces (e.g., 14, 16 and/or 18) of the weathering block 10 with the aid of built-in hooks or grasps at the top ledge tl and/or the bottom ledge bl of the various surfaces (e.g., 14, 16 and/or 18). For example, the weathering block 10 can be manufactured to include built-in hooks or grasps at the various surfaces (e.g., 14, 16 and/or 18) to maintain the weather-stripping pieces 20-25.

The weather-stripping can be of any suitable size and/or shape as long as the weather-stripping is maintained in the various surfaces (i.e., 14, 16 and 18) of the weathering block 10. In an embodiment, the weathering block 10 includes a single strip of weather-stripping pieces 20-25 approximately 0.187 inches thick that extend out from the weathering block 10 (as illustrated in FIG. 2A and FIG. 2B). In an embodiment, the weathering block 10 includes multiple rows of weather-stripping pieces 20-25 approximately 2.6 inches thick that extend out from the weathering block 10. The weather-stripping pieces 20-25 can have a height ranging from about 0.13 inches to about 0.75 inches.

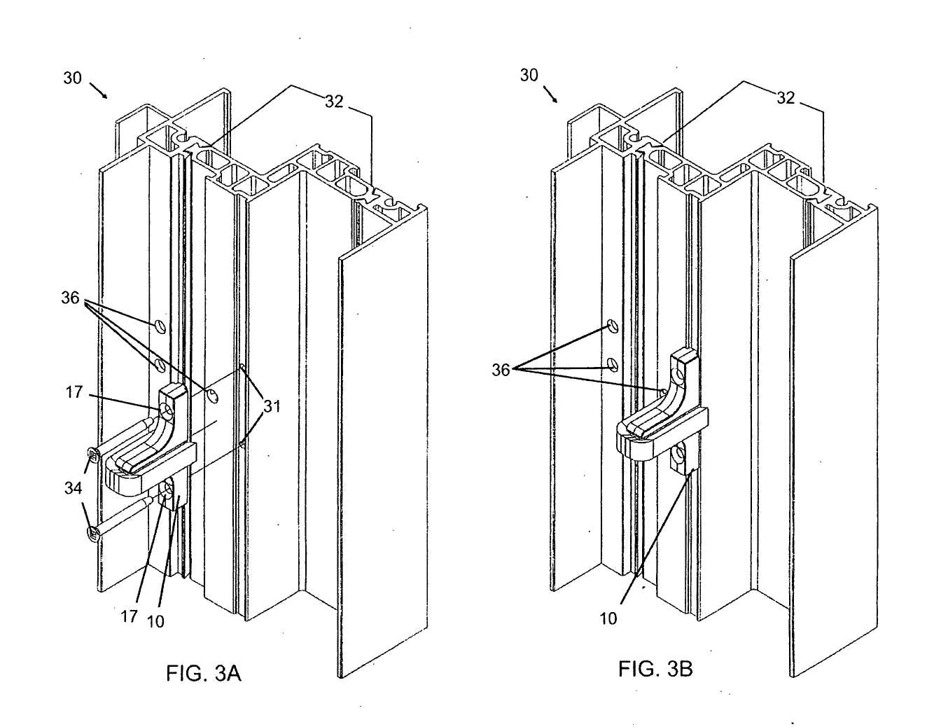

FIG. 3A and FIG. 3B illustrates the weathering block 10 and a side jamb 30 of a single-hung window frame. FIG. 3A shows the weathering block 10 prior to engagement to a center parting fin 32 of the side jamb 30. Fasteners 34 are positioned within openings 17 of the weathering block 10 and fastened into holes 31 of the center parting fin 32 to secure the weathering block 10 to the single-hung window frame (see FIG. 3B). Holes 36 in the side jamb 30 of the single-hung window frame are used to connect a fixed lite window to the frame. In an embodiment, the center parting fin 32 is a thermal break, a material which is a poor conductor of heat. In an embodiment, the thermal break is a polyamide thermal break. The unique shape of the thermal break enhances the performance of the single-hung window by maintaining the continuity of the thermal break throughout the window frame and sash.

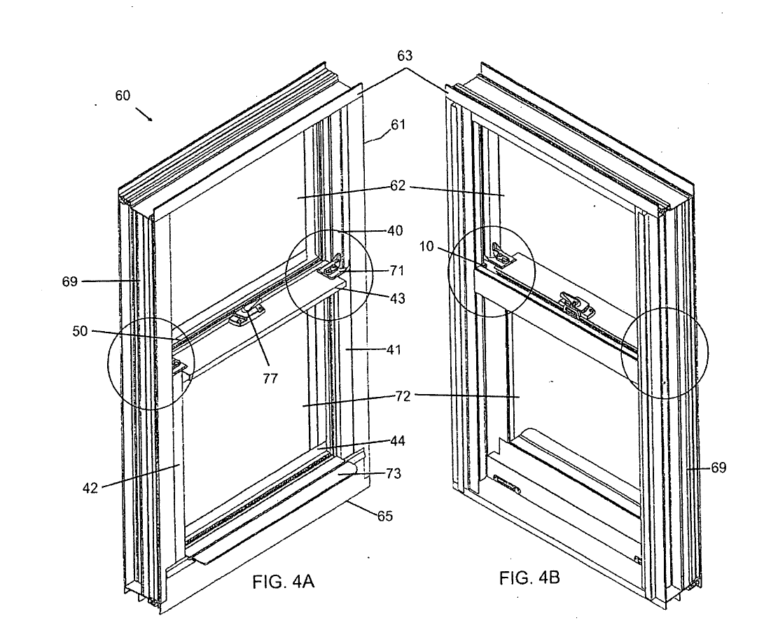

FIG. 4A and FIG. 4B illustrates an embodiment of a single-hung window 60 having the weathering block 10 of the present invention. FIG. 4A shows the single-hung window 60 as viewed from an interior of a dwelling. FIG. 4B shows the single-hung window 60 as viewed from an exterior of a dwelling. The single-hung window 60 includes a frame 61 having a head jamb 63, a sill plate 65, a first side jamb 40, and a second side jamb 69. A fixed lite window 62 is constructed in the frame 61, and has a fixed meeting rail member 50. A lower sash 72 is vertically moveable in the frame 61, and has a locking rail 43, a bottom rail 44, a first side stile 41, and a second side stile 42. Two weathering blocks 10 of the present invention are positioned at a center parting fin of the side jambs 40 and 69 in the single-hung window frame 61, approximately at the circled regions in FIGS. 4A and 4B. In an embodiment, the single-hung window 60 includes a sweep lock and keeper 77 which provides security at the meeting rails 43 and 50. In an embodiment, the single-hung window 60 includes sash cams 71 located left and right on the sash 72 that insure proper alignment and smooth operation.

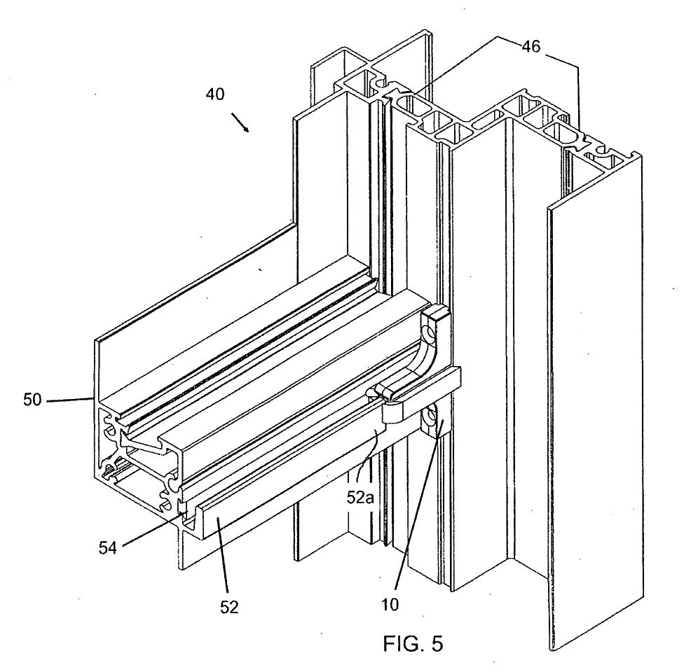

FIG. 5 is a fragmentary isometric view of some of the main components of the fixed lite window 62 of the single-hung window 60 of FIG. 4A. The weathering block 10 engages a center parting fin 46 of the first side jamb 40 of the single-hung window frame 61. The fixed meeting rail member 50 of the fixed lite window 62 is illustrated in FIG. 5. The fixed meeting rail member 50 includes an interlock 52 that can engage, by fitting together, with the locking rail 43 of the lower sash 72. Horizontal weather-stripping 54 (having similar or different characteristics as the weather-stripping pieces 20-25 of the weathering block 10) positioned in the fixed meeting rail member 50 engages the weather-stripping of the weathering block 10, for example at weather-stripping piece 24. The interlock 52 is positioned such that end 52a engages the weather-stripping maintained in the front surface 14 of the weathering block 10.

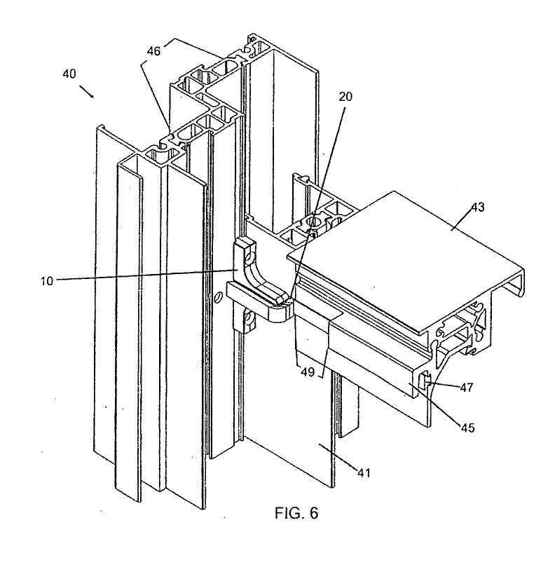

FIG. 6 is a fragmentary isometric view of some of the main components of the single-hung window 60 of FIG. 4B. The lower sash 72 is vertically moveable in the frame 61 and includes the locking rail 43, and the first side stile 41. The locking rail 43 includes an interlock 45 that has a portion 49 removed. In a closed position, horizontal weather-stripping 47 positioned in the locking rail 43 engages the weather-stripping of the weathering block 10, for example weather-stripping pieces 20 and 21. Further, the weather-stripping piece 20 of the weathering block 10 contacts the first side stile 41 of the lower sash 72. The weather-stripping piece 20 substantially maintains continuity with the weather-stripping 47. As the lower sash 72 moves vertically within the frame 61, the weather-stripping 47 moves with the lower sash 72, while the weather-stripping pieces 20-25 of the weathering block 10 remain attached to the weathering block 10, thus maintaining contact with the first side stile 41 of the lower sash 72. It is believed that the positioning of the fixed meeting rail member 50, the weathering block 10, and the weather-stripping pieces 20-25 with the locking rail 43 substantially eliminates gaps that may exist between the frame 61, the fixed lite window 62 and the lower sash 72, thus substantially preventing air infiltration. A secondary result can also include keeping interior air in the dwelling, thus saving energy with heating and air conditioning.

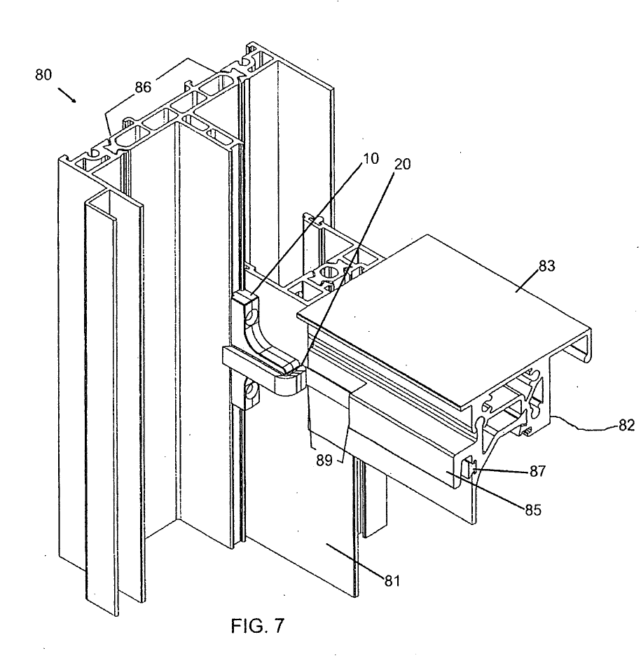

FIG. 7 is a fragmentary isometric view of some of the main components of a lower sash 82 of a double-hung window having the weathering block 10 of the present invention (not all parts of the double-hung window are illustrated in FIG. 7). The double-hung window includes a frame having a head jamb (not illustrated), a sill plate (not illustrated), a first side jamb 80 and a second side jamb (not illustrated). A top sash (not illustrated) is vertically moveable in the frame and includes a top rail, a keeper rail, a first side stile, and a second side stile. The lower sash 82 is vertically moveable in the frame and includes a locking rail 83, a bottom rail (not visible), a first side stile 81, and a second side stile (not visible). The locking rail 83 includes an interlock 85 that has a portion 89 removed. In a closed position, horizontal weather-stripping 87 positioned in the locking rail 83 engages the weather-stripping of the weathering block 10, for example weather-stripping pieces 20 and 21. Although not illustrated in FIG. 7, in the closed position, the first side surface 16 of the weathering block 10 contacts the first side stile of the top sash. More particularly, the weather-stripping piece 25 maintained in the first side surface 16 of the weathering block 10 contacts the first side stile of the top sash. Further, the weather-stripping piece 20 of the weathering block 10 contacts the first side stile 81 of the lower sash 82. The weather-stripping piece 20 substantially maintains continuity with the weather-stripping 87. As the lower sash 82 moves vertically within the frame, the weather-stripping 87 moves with the lower sash 82, while the weather-stripping pieces 20-25 of the weathering block 10 remain attached to the weathering block 10, thus maintaining contact with the first side stile 81 of the lower sash 82. It is believed that the positioning of the keeper rail of the top sash, the weathering block 10, and the weather-stripping pieces 20-25 with the locking rail 43 substantially eliminates gaps that may exist between the frame, the top sash, and the lower sash 82, thus substantially preventing air infiltration. A secondary result can also include keeping interior air in the dwelling, thus saving energy with heating and air conditioning.

In an embodiment, the weathering block 10 of the present invention can be used with a horizontal sliding/gliding window. In an embodiment, the horizontal sliding/gliding window includes a frame having a head jamb, a sill plate, a first side jamb, and a second side jamb; a fixed lite window constructed in the frame, the fixed lite window having a fixed meeting stile member; at least one moveable sash in the frame, the sash having a top rail, a bottom rail, a first side stile, and a second side stile; a first weathering block having: a back surface engaging the head jamb of the frame; a front surface having weather-stripping; a first side surface sufficiently designed to maintain weather-stripping; and a second side surface sufficiently designed to maintain weather-stripping; and a second weathering block having: a back surface engaging the sill plate of the frame; a front surface having weather-stripping; a first side surface sufficiently designed to maintain weather-stripping; and a second side surface sufficiently designed to maintain weather-stripping. In an embodiment, when the horizontal sliding/gliding window is in a closed position air infiltration is substantially prevented. In an embodiment, when the horizontal sliding/gliding window is in a closed position interior air is substantially kept in a dwelling having the horizontal sliding/gliding window.

In an embodiment, the weathering block 10 of the present invention can be used with a sliding door assembly. In an embodiment, the sliding door assembly includes a frame having a head jamb, a sill plate, a first side jamb, and a second side jamb; a sliding door movable between a closed position and an open position, the sliding door having a top rail, a bottom rail, a first side stile, and a second side stile; a fixed-panel door maintained in a stationary position, the fixed-panel door having a fixed meeting stile; a first weathering block having: a back surface engaging the head jamb of the frame; a front surface having weather-stripping; a first side surface sufficiently designed to maintain weather-stripping; and a second side surface sufficiently designed to maintain weather-stripping; and a second weathering block having: a back surface engaging the sill plate of the frame; a front surface having weather-stripping; a first side surface sufficiently designed to maintain weather-stripping; and a second side surface sufficiently designed to maintain weather-stripping. In an embodiment, when the sliding door is in a closed position air infiltration is substantially prevented. In an embodiment, when the sliding door is in a closed position interior air is substantially kept in a dwelling having the sliding door assembly.

While illustrative embodiments of the invention are disclosed herein, it will be appreciated that numerous modifications and other embodiments may be devised by those skilled in the art. Therefore, it will be understood that the appended claims are intended to cover all such modifications and embodiments that come within the spirit and scope of the present invention.

What is claimed is:

1. A single-hung window comprising:
a frame having a head jamb, a sill plate, a first side jamb, and a second side jamb;
a fixed lite window constructed in the frame, the fixed lite window having a fixed meeting rail member;
a lower sash vertically moveable in the frame, the lower sash having a locking rail, a bottom rail, a first side stile, and a second side stile; and
a first weathering block comprising:
a back surface engaging the first side jamb of the frame;
a front surface having weather-stripping;
a first side surface sufficiently designed to maintain weather-stripping; and
a second side surface sufficiently designed to maintain weather-stripping,
wherein, when the lower sash is in a closed position the first side surface of the first weathering block contacts the fixed meeting rail of the fixed lite window and the second side surface of the first weathering block contacts the first side stile of the vertically moveable lower sash.

2. The single-hung window of claim 1 wherein the back surface of the first weathering block engages the first side jamb of the frame at a center parting fin.

3. The single-hung window of claim 2 wherein the center parting fin is a thermal break.

4. The single-hung window of claim 1 wherein the first weathering block is constructed from a material selected from the group consisting of aluminum, aluminum alloys, vinyl, fiberglass reinforced plastics, thermoplastic polymers, wood and steel.

5. The single-hung window of claim 4 wherein the thermoplastic polymer is one of polyvinyl chloride or acrylonitrile butadiene styrene.

6. The single-hung window of claim 4 wherein the fiberglass reinforced plastic comprises nylon fibers.

7. The single-hung window of claim 1 wherein the first weathering block has a T-shape.

8. The single-hung window of claim 1 wherein an interlock on the meeting rail of the fixed lite window engages the weather-stripping on the front surface of the first weathering block.

9. The single-hung window of claim 8 wherein the back surface of the first weathering block engages the first side jamb of the frame using screws fastened through the first weathering block and threading into the frame.

10. The single-hung window of claim 1 further comprising a second weathering block having:
a back surface engaging the second side jamb of the frame;
a front surface having weather-stripping;
a first side surface sufficiently designed to maintain weather-stripping; and
a second side surface sufficiently designed to maintain weather-stripping,
wherein, when the lower sash is in a closed position the first side surface of the second weathering block contacts the meeting rail of the fixed lite window and the second side surface of the second weathering block contacts the second side stile of the vertically moveable lower sash.

11. A double-hung window comprising:
a frame having a head jamb, a sill plate, a first side jamb, and a second side jamb;
a top sash vertically moveable in the frame, the top sash having a top rail, a keeper rail, a first side stile, and a second side stile;
a lower sash vertically moveable in the frame, the lower sash having a locking rail, a bottom rail, a first side stile, and a second side stile; and
a first weathering block comprising:
a back surface engaging the first side jamb of the frame;
a front surface having weather-stripping;
a first side surface sufficiently designed to maintain weather-stripping; and
a second side surface sufficiently designed to maintain weather-stripping,
wherein, when the lower sash and the top sash are in a closed position the first side surface of the first weathering block contacts the first side stile of the top sash and the second side surface of the first weathering block contacts the first side stile of the lower sash.

12. The double-hung window of claim 11 wherein the back surface of the first weathering block engages the first side jamb of the frame at a center parting fin.

13. The double-hung window of claim 12 wherein the center parting fin is a thermal break.

14. The double-hung window of claim 11 wherein the first weathering block is constructed from a material selected from the group consisting of aluminum, aluminum alloys, vinyl, fiberglass reinforced plastics, thermoplastic polymers, wood and steel.

15. The double-hung window of claim 14 wherein the thermoplastic polymer is one of polyvinyl chloride or acrylonitrile butadiene styrene.

16. The double-hung window of claim 14 wherein the fiberglass reinforced plastic comprises nylon fibers.

17. The double-hung window of claim 11 wherein the first weathering block has a T-shape.

18. The double-hung window of claim 11 wherein the back surface of the first weathering block engages the first side jamb of the frame using screws fastened through the first weathering block and threading into the frame.

19. The double-hung window of claim 11 further comprising a second weathering block having:
a back surface engaging the second side jamb of the frame;
a front surface having weather-stripping;
a first side surface sufficiently designed to maintain weather-stripping; and
a second side surface sufficiently designed to maintain weather-stripping,
wherein, when the lower sash and the top sash are in a closed position the first side surface of the second weathering block contacts the second side stile of the top sash and the second side surface of the second weathering block contacts the second side stile of the lower sash.

20. A horizontal sliding window comprising:
a frame having a head jamb, a sill plate, a first side jamb, and a second side jamb;
a fixed lite window constructed in the frame, the fixed lite window having a fixed meeting stile member;
at least one moveable sash in the frame, the sash having a top rail, a bottom rail, a first side stile, and a second side stile;
a first weathering block comprising:
a back surface engaging the head jamb of the frame;
a front surface having weather-stripping;
a first side surface sufficiently designed to maintain weather-stripping; and
a second side surface sufficiently designed to maintain weather-stripping; and
a second weathering block comprising:
a back surface engaging the sill plate of the frame;
a front surface having weather-stripping;
a first side surface sufficiently designed to maintain weather-stripping; and
a second side surface sufficiently designed to maintain weather-stripping.
